(19) United States
(12) Patent Application Publication
(10) Pub. No.: US 2025/0193077 A1
(43) Pub. Date: Jun. 12, 2025

(54) METHOD AND APPARATUS FOR DETERMINING OPTIMIZED NETWORK CONFIGURATION

(71) Applicant: CEBURU SYSTEMS, INC., Santa Rosa, CA (US)

(72) Inventors: Jaseem MASOOD, Petaluma, CA (US); Rehan KHAN, SW Ranches, FL (US)

(21) Appl. No.: 19/052,269

(22) Filed: Feb. 12, 2025

Related U.S. Application Data
(63) Continuation-in-part of application No. 18/124,556, filed on Mar. 21, 2023, now abandoned.
(63) Continuation-in-part of application No. 18/124,557, filed on Mar. 21, 2023.
(60) Provisional application No. 63/552,663, filed on Feb. 12, 2024.

(51) Int. Cl. H04L 41/0816; H04L 41/16; H04L 43/08

(52) U.S. Cl. CPC H04L 41/0816; H04L 41/16; H04L 43/08

(57) ABSTRACT

A method and apparatus for determining optimized network configuration includes receiving, at a performance analysis server (PAS), a plurality of performance parameters for each of the plurality of nodes, and a plurality of network parameters. The method includes generating, using an artificial intelligence and/or machine learning (AI) engine, based on the plurality of performance parameters, a network status for the plurality of nodes. The network status includes a performance state determined based on the performance parameters, a network state determined based on the network parameters, and at least one performance parameter or at least network parameter causing the performance state or the network state respectively. The method includes determining a configuration change based on performance parameters or the network parameters.

### CROSS-REFERENCE TO RELATED APPLICATIONS

This application claims the benefit of U.S. patent application Ser. No. 18/124,556, titled “METHOD AND APPARATUS FOR PREDICTING FAILURE IN A NETWORKED ENVIRONMENT,” and U.S. patent application Ser. No. 18/124,557 titled “METHOD AND APPARATUS FOR PREDICTING MAINTENANCE REQUIREMENTS OF A PRINTING DEVICE,” and U.S. Provisional Application Ser. No. 63/552,663 titled “METHOD AND APPARATUS FOR DETERMINING OPTIMIZED NETWORK CONFIGURATION” filed on Feb. 12, 2024, each incorporated by reference in their entirety.

### FIELD

The present invention relates to network monitoring, and more specifically to determining optimized network configuration.

### BACKGROUND

Today's computing deployments are increasingly complex and include a large number of nodes, for example, devices or hardware entities, software entities, communication, and other resources. Often, such nodes experience performance issues or events, including degradation or failure due to transient or persistent issues, or performance states. Occurrence of such performance events can lead to deterioration of service for customers using services or functionality of the nodes, damage to the nodes experiencing the performance events, issues with other nodes in the network, and several others, as known in the art. Conventional solutions have generally been deficient in terms of accuracy, coverage, and timeliness in identifying such events proactively, and causes thereof. Furthermore, organizations spend significant resources and time updating network configuration, and still have failure due to sub-optimal network configuration.

Accordingly, there is a need in the art for methods and apparatuses for determining optimized network configuration.

### SUMMARY

The present invention provides a method and an apparatus for determining optimized network configuration, substantially as shown in, and/or described in connection with at least one of the figures, as set forth more completely in the claims. These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a computing apparatus for determining optimized network configuration, in accordance with an embodiment.

FIG. 2 depicts a flow diagram of a method for determining optimized network configuration, in accordance with an embodiment.

FIG. 3 depicts a functional representation of a computation module for determining optimized network configuration, in accordance with an embodiment.

FIG. 4 depicts a flow diagram of a method for determining optimized network configuration, in accordance with an embodiment.

### DETAILED DESCRIPTION

Embodiments of the present invention relate to a method and an apparatus for determining optimized network configuration, such as, a computing environment with several nodes, of which at least some nodes are communicably coupled or networked via a network. For example, the nodes may be communicatively coupled in computing environments of enterprises, including, but not limited to, on-premise deployments, cloud deployments, hybrid deployments, among others. In particular, the disclosed techniques include monitoring all performance parameters in the network, for example, by recording and sending, or streaming such parameters corresponding to each node, and applying an artificial intelligence (AI) and/or machine learning (ML) models (“model(s) or AI model(s)”) to determine a status of a node with different than expected performance, for example, degradation, failure, or unexpected increase, and a cause or potential cause therefor.

Further, the techniques include determining a probability of an undesirable performance event for the node at a time in the future, based on the status of the node, and optionally, the performance parameters. Additionally, the probability and performance parameters are used by an AI model to predict an occurrence of a performance event for the node in the future, for example, performance degradation or failure of the node, or another node or service in the customer environment.

In some embodiments, the method includes generating recommendations to avoid the occurrence of the undesirable performance event (e.g., failure) at the node, to isolate the node, retire the node gracefully, and/or perform such or other known mitigating actions based on a user input or automatically.

In some embodiments, the method includes identifying cause of failure of the existing or the predicted failure events. For example, the performance of such network components, applications, or parameters such as traffic patterns and user behavior, and the like, are compared to standard network operation guidelines, and deviations are identified. Such deviations are then evaluated as a potential cause of the performance degradation or potential future performance degradation, and one or more of the deviations are identified as a cause(s).

In some embodiments, the method includes optimizing the network configuration, including, but not limited to, network components, applications, or parameters such as traffic, bandwidth, and usage patterns based on the identified causes. For example, the identified causes are evaluated against guidelines for such (standard) network configurations, and the entire network is evaluated for possible changes, replacements, or other manipulations, that if made, would remedy the causes for the performance degradation or the potential future performance degradation.

In some embodiments, the method includes executing the configuration changes by transmitting a set of signals. In some embodiments, the signals include one or more instructions executable by each node. In other embodiments, the signals may indicate to an operator to manually execute the configurations.

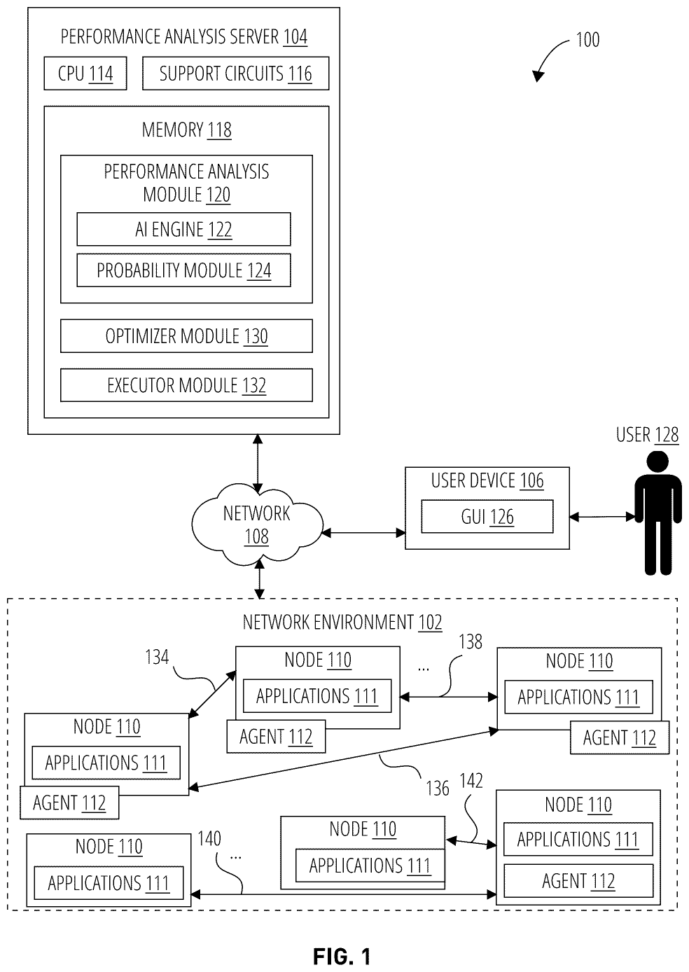

Various embodiments of the present disclosure are described in detail in reference to FIGS. 1 through 4.

FIG. 1 depicts computing apparatus 100 for determining optimized network configuration, in accordance with an embodiment. The computing apparatus 100 includes a network environment 102, a user device 106, a performance analysis server (PAS) 104 or server 104, and a network 108 communicably coupling the network environment 102, the user device 106 and the PAS 104.

The network environment 102 includes a plurality of nodes 110, each individually referred to as a node 110. The nodes 110 of the network environment 102 are communicatively coupled via an internal communication network (shown as 134 to 142 in FIG. 1), and include devices (hardware entities) and software-based entities (such as applications 111), and other known entities used in networks or computing environments. The nodes 110 include computers, routers, switches, firewalls, servers, hubs, repeaters, virtual machines, containers, printers, scanners, internet of thing (IoT) devices, point-of-sale (PoS) devices (such as those used in supermarkets and shops), interconnected set of computing devices (such as in schools, universities, offices, servers, decentralized networks, cyber cafes), telecommunication network, network of medical devices, and the like, but not limited thereto, and are deployed in configurations as known in the art.

One or more performance parameters may be monitored/collected by the nodes 110. The performance parameters or performance logs of the node 110 relate to any of its hardware components, software components, communication, or an external component such as third-party services or devices, and such performance logs or performance parameters may also include logs for communication over one or more of hardware layers, software layers or transport layer, among others, according to the open systems interconnection (OSI) model. In some embodiments, the performance parameters include information for all the seven layers of the OSI model. Scanning all seven layers ensures that all performance logs or performance parameters (and all issues) from all seven layers are considered in the analysis using the present techniques, and enables identifying any issues in any of the seven layers. In some embodiments, the performance parameters include, but not be limited to, device performances, errors, usage timing, utilization of the network bandwidth, network key performance indicators (KPI), current network configuration, topology, segmentation, software versions of the plurality of nodes, traffic patterns, check protocol performances, security measures, Internet Protocol (IP) provisioning, network diameter, jitter, power consumption, Voice-over IP (VOIP) quality, hardware-specific parameters, or the like. The hardware-specific performance parameters may include, for example, time, location, activity, utilization, network traffic, network bandwidth, network configuration, subnet configuration, manufacturing specifications, or physical conditions of or at the node, such as temperature, humidity, pressure, air flow, or the like, but not limited thereto.

Each node 110 includes or is associated with an application 111 and an agent 112. For example, nodes 110 that are hardware devices or virtual machines may include the application 111 and the agent 112 installed therein. In some embodiments, agent 112 and the application 111 may be implemented as a combination of hardware and software components. In some embodiments, the application 111 may be indicative of a software module and a hardware module, configured to provide an intended functionality. In some examples, the application 111 may be a messaging application. In some embodiments, the agent 112 may be configured to record performance parameters for the node 110, and send the performance parameters to the PAS 104. In some embodiments, the agent 112 may be implemented as an application 111. The agent 112 is also configured to respond to queries for performance parameter information from the PAS 104. In some embodiments, the agent 112 sends the performance parameters continuously, such as, via streaming. In some embodiments, the agent 112 sends the responses instantaneously, periodically, upon caching a particular quantity of data, or any combination thereof. The network environment 102 further includes a probe, which is a master node in the network environment 102. The probe is configured to scan and discover nodes 110, deploy agents 112 for all nodes 110, and further, collect information from all agents 112 to transmit to the PAS 104, for example, to a performance analysis module 120 of the PAS 104. In some embodiments, one or more of the agents 112 is configured to include the functionality of the probe. It is appreciated here that the agent 112 is also an application running on the node, or on another device, but associated with one or more nodes.

In some embodiments, each node 110 and associated agent 112 is identifiable by an identifier or an ID. In some examples, each node 110 may be uniquely identified by any one or combination of including, but not limited to, Internet Protocol (IP) address, Media Access Control (MAC) address, a Universally Unique Identifier (UUID), or any other unique identifier assigned to the node 110.

In some embodiments, the nodes 110 of the network environment 102 are communicatively coupled via communication channels known in the art separate from the network 108, for example, connections 134, 136, 138, 140, 142 and so on. In other embodiments, the nodes 110 are communicably coupled via the network 108. In some embodiments, some of the nodes 110 are communicatively coupled via the communication channels, and some of the nodes 110 are communicatively coupled via the network 108. In some embodiments, the nodes 110 are not a part of the network environment 102, and instead are individually communicatively coupled via the network 108.

The PAS 104 includes a Central Processing Unit (CPU) 114 communicatively coupled to support circuits 116 and a memory 118. The CPU 114 may be any commercially available processor, microprocessor, microcontroller, electronic circuit, digital signal processor, integrated circuit, and the like. The support circuits 116 comprise well-known circuits that provide functionality to the CPU 114, such as, a user interface, clock circuits, network communications, cache, power supplies, I/O circuits, and the like. The memory 118 is any form of digital storage used for storing data and executable software, which are executable by the CPU 114. Such memory 118 includes, but is not limited to, random access memory, read only memory, disk storage, optical storage, various non-transitory storages known in the art, and the like. The memory 118 includes computer readable instructions corresponding to an operating system and other routine functions (not shown), and the performance analysis module 120. The performance analysis module 120 may include an AI engine 122, and a probability module 124. In some embodiments, the PAS 104 is deployed in the cloud. In some embodiments, the PAS 104 is deployed in an enterprise owner's environment, such as, enterprise cloud, enterprise premises, and the like, for example, in the network environment 102.

The performance analysis module 120 is configured to identify a node displaying an unusual performance, such as degraded performance or failure, cause thereof, predict such unusual performance and cause thereof, and either based on an instruction or automatically, mitigate the unusual performance identified or predicted.

The performance analysis module 120 is also configured to receive a set of network parameters from the network environment 102. In such embodiments, the network parameters may include, but not be limited to, traffic, bandwidth, anomalies, and usage data, for example, for the connections 134-142. The network parameters may be associated with at least one layer of the OSI model, or usage of the node or the network environment. The traffic parameter may correspond to the number of requests for processing of data, or provisioning of a service, received by the nodes 110 in the network environment 102. The bandwidth parameter may correspond to capacity of the nodes 110 in the network environment 102 for processing each of the requests. In some examples, for a given traffic (e.g. processing of 1000 requests) between two of the nodes 110, the network environment 102 may be suitably optimized to expand the bandwidth, i.e. capacity to handle each of the requests within the intended amount of time for such nodes 110. In other examples, the bandwidth parameter may indicate the amount of network resources consumed by each of the nodes 110. The nodes 110 that consume higher bandwidths (i.e., the nodes 110 that transmit larger payloads/data packets to transmit payloads more frequently) may be allocated more network resources compared to other nodes 110 consuming comparatively less bandwidth. In some examples, when the network environment 102 is implemented as a set of IoT devices that control the generation and supply of electric power from a hydroelectric power plant based on demand (i.e. traffic), the network environment 102 may autonomously cause the hydroelectric power plant to generate more or less electric power by opening or closing turbines corresponding to each IoT device based on the bandwidth parameter, thereby expanding or contracting the bandwidth/capacity/operation of the network environment 102. In some examples, the bandwidth parameter may be optimized either for speed, or for time, resource consumption, or energy efficiency.

The usage parameter corresponds to the user behaviour, or user patterns. In some examples, the bandwidth consumed by each of the nodes 110 may change at different times of the day. A first node may consume more bandwidth than a second node in the morning, and vice-versa in the evening. The usage parameter may indicate patterns in the usage of resources in the network environment 102. In another example, the usage parameter may indicate consumers of electric power typically consume more electric power during the day (such as for air-conditioning and cooling) compared to evening or night. Nodes 110 may be configured to adapt their operation in response to the usage pattern. In further examples, the usage parameters websites visited, login frequency, resource utilization, time of use of certain programs, and the like, but not limited thereto. The usage parameter may also be associated with individual nodes in the network environment 102 (which may be uniquely identifiable through Internet Protocol (IP) addresses, for example). The network parameters may be generated at each of the nodes 110 of the network environment 102, and collected/aggregated either at one of the nodes 110 or at the PAS 104. The network parameters may be extracted from network logs, node logs, IP address logs, Domain Name Service (DNS) logs, and the like, but not limited thereto.

The performance analysis module 120 receives the identifiers and the performance parameters of each of the nodes 110 from the agents 112, for example, via the network 108. The performance analysis module 120 also receives the network parameters from the network environment 102 (or the nodes 110 thereof). The performance analysis module 120 may aggregate the network parameters received from each of the nodes 110.

The performance parameters and the network parameters for multiple nodes 110 are fed to the AI engine 122. The AI engine 122 may be configured to generate a network status of the plurality of nodes 110 forming the network environment 102. The network status includes a performance state associated with each of the nodes 110, a network state associated with the plurality of nodes 110/the network environment 102, and at least one performance parameter and/or at least network parameter causing the performance state or the network state respectively.

The AI engine 122 may identify one or more nodes, for example, via the identifier thereof, from multiple nodes 110, that are experiencing an unusual (degraded, failed, or otherwise aberrant) performance state. The AI engine 122 also identifies the unusual performance state, and a performance parameter of the identified node, or a performance parameter of another node causing the unusual performance state of the identified node, together referred to as the status of the node experiencing the unusual performance state. For example, the AI engine 122 may identify a status for a router node (among the nodes 110), an identifier of the router node (such as an IP address, or a MAC address, or a combination thereof), the performance state that the bandwidth of the connection to a connected device to the router node is low, and the performance parameter causing the low bandwidth as the temperature of the router, which is higher than is considered optimal.

The AI engine 122 may identify the network state of the plurality of nodes 110/the network environment 102. The network state may indicate the performance of the network environment 102. In some embodiments, the AI engine 122 may be configured to quantify the network parameters in numeric values, and determine the network state therewith. In some embodiments, the network state may also be a numeric value. In such embodiments, the absolute value of the network parameters and the network state may be compared with corresponding threshold ranges to determine if the network environment 102 is performing optimally. In other embodiments, the network state may be any one class/label from a set of classes/labels having an ordinal relationship. In some embodiments, the network state, quantified in numeric values, may be assigned a corresponding label based on whether the numeric values are within numeric ranges associated with at least one of the classes/labels of the set of classes/labels. The performance analysis module 120 may send the network status to an administrator of the customer environment 102, for example, the user 128, via the network 108, for display on a Graphical User Interface (GUI) 126 of the user device 106.

A probability module 124 (implemented in the memory 118) is configured to forecast the network status of the network environment 102 for a future time interval(s). In some examples, the probability module 124 may forecast the network status (such as performance state of each of the nodes 110, and the network state) for a configurable number of days (or any other time interval/duration). Future time interval may be suitably adapted based on requirements and context. The network status of the nodes 110 generated by the AI engine 122 is used by the probability module 124 to compute a probability of occurrence of a performance event for the nodes 110, such as a failure of the node, degradation of the service at the node or provided by the node, or a potential of harm to another node, at a given future time interval. In some embodiments, the performance event may cause the network state or the performance state to fall outside their corresponding thresholds. The probability module 124 also uses network status generated by the AI engine 122 to determine the probability of occurrence of the performance event appreciably affecting the network state of the network environment 102.

In some embodiments, the probability module 124 further uses one or more of historical network status data, or the performance parameters causing the performance state for the node 110, and the network parameters causing the network state for computing the probability to forecast the network status for the future time interval. In the router node example, the probability module 124 uses the low bandwidth performance state, high temperature of the router node as the cause of the low bandwidth, and computes, for a particular time interval in the future, a probability of occurrence of a performance event, such as degradation of service of the router, failure of the router, potential of harm to a network storage device (not shown), and the like. The probability module 124 may also take into consideration the historical statuses and/or temperature parameter of the router, or only those historical statuses of the router in which the temperature was high, to compute the probability. In some embodiments, the probability module 124 computes the probability for several future time intervals, and identifies a time interval for which the probability meets or exceeds a threshold probability score.

The probability data generated by the probability module 124, for example, all probability scores, or only the probability scores meeting or exceeding the threshold, is provided to the AI engine 122. Based on the probability data for a given node, and the performance parameters of the nodes 110 received from the network environment 102, the AI engine 122 predicts the performance event for the given node or another node in the network environment 102, and the performance parameter causing the predicted performance event, in a time interval or a specific time in the future. The time interval predicted by the AI engine 122 may be the same as or different from the time intervals considered by the probability module 124 for generating the probability scores. In the router node example, the AI engine 122 may predict that for the router (identified using the corresponding identifier) the overall router performance will degrade below a predefined performance threshold (performance event), between 75 hours to 78 hours from now, due to the high temperature (performance state).

The performance analysis module 120 sends this information, viz., the router identifier, the performance event (performance degradation), the performance state at cause (high temperature), and the predicted time interval for the performance event (75 hours to 78 hours from now), to the administrator of the network environment 102, so that mitigation actions may be taken. In some embodiments, the performance analysis module 120 is configured to perform mitigation actions, either based on receiving an input from the administrator, for example, from the user device 106 used by a user 128, via the network 108, or automatically based on pre-configured rules. Mitigation actions include, without limitation, creating a backup of the node 110 or a functionality thereof, upgrading the node 110, isolating the node 110, or shutting down the node 110.

In some embodiments, the AI engine 122 is configured to model the network environment 102 and its nodes 110 using a Finite State Machine (FSM) framework, wherein the network state and performance states of nodes are mapped to predefined states with dynamically adaptive transitions. In this embodiment, the network and associated appliances are represented by discrete FSM states, each reflecting a specific set of performance conditions. The FSM framework defines distinct operational states of the network environment and/or nodes, including:
Optimal State (S1): The network or node operates within expected parameters (e.g., low latency, minimal packet loss, stable bandwidth utilization).
Degraded State (S2): Early signs of performance degradation are observed (e.g., moderate latency spikes, increased jitter, or bandwidth saturation).
Warning State (S3): Significant degradation occurs that necessitates close monitoring for potential intervention (e.g., persistent high latency or packet loss).
Failure State (S4): Critical performance failure is detected (e.g., severe packet loss, connection timeouts).
Recovery State (S5): The network or node is in a post-intervention phase, transitioning back toward optimal performance.

State transitions between these FSM states are determined by machine learning (ML) models trained on both historical and real-time network data, rather than relying solely on fixed thresholds. For example, transitions may be triggered by deviations in key metrics such as latency, packet loss, bandwidth utilization, or error rates. Specific transitions include:
T1 (S1 to S2): Triggered when performance metrics begin to deviate moderately (e.g., latency exceeding a baseline threshold, jitter increases, or bandwidth utilization reaching a high level).
T2 (S2 to S3): Initiated when these deviations become more pronounced (e.g., critical latency levels or significant packet loss).
T3 (S3 to S4): Occurs when performance deterioration continues unabated, leading to severe network conditions.
T4 (S4 to S5): Initiated when corrective actions yield improvements, marking the onset of recovery.
T5 (S5 to S1): Finalized once the network or node returns to performance levels within the normal range.

The approach to integrating ML with the FSM involves several steps, including feature extraction, model training, continuous learning, and mapping to network parameters and/or performance parameters. Specifically, for feature extraction, the AI engine 122 extracts detailed features from network performance metrics (e.g., latency, jitter, packet loss, and error rates). Model Training includes training an ML model, such as a Random Forest classifier, using historical network data (network parameters, performance parameters) to predict the likelihood of transitions between FSM states based on observed patterns. Continuous Learning includes updating the ML model continuously with real-time data, enabling dynamic refinement of transition thresholds and logic. Mapping to network parameters includes mapping the FSM states directly to the network parameters (e.g., OSI-layer anomalies, traffic patterns, hardware-specific metrics) so that the AI engine can identify and recommend configuration changes that steer the network toward a desired state.

For instance, if the ML model predicts a transition to a Degraded State (S2) due to factors such as bandwidth saturation, the optimizer module 130 may recommend dynamic resource reallocation or traffic redistribution. Conversely, upon detecting improved metrics (e.g., reduced latency), the system transitions to the Recovery State (S5) and may trigger corrective actions such as reactivating isolated nodes.

Such embodiments with FSM-ML integration enables adaptive decision-making because the thresholds for state transitions are not static but evolve based on continuous learning from historical and real-time data. Such integration further enables predictive analytics in which the system can forecast impending performance degradations or failures, enabling preemptive configuration changes. Such embodiments enable self-improvement by correlating predicted states with actual outcomes, and the apparatus refines its predictive accuracy over time. These embodiments also enhance network stability by proactive adjustments that help maintain optimal network performance and reduce downtime.

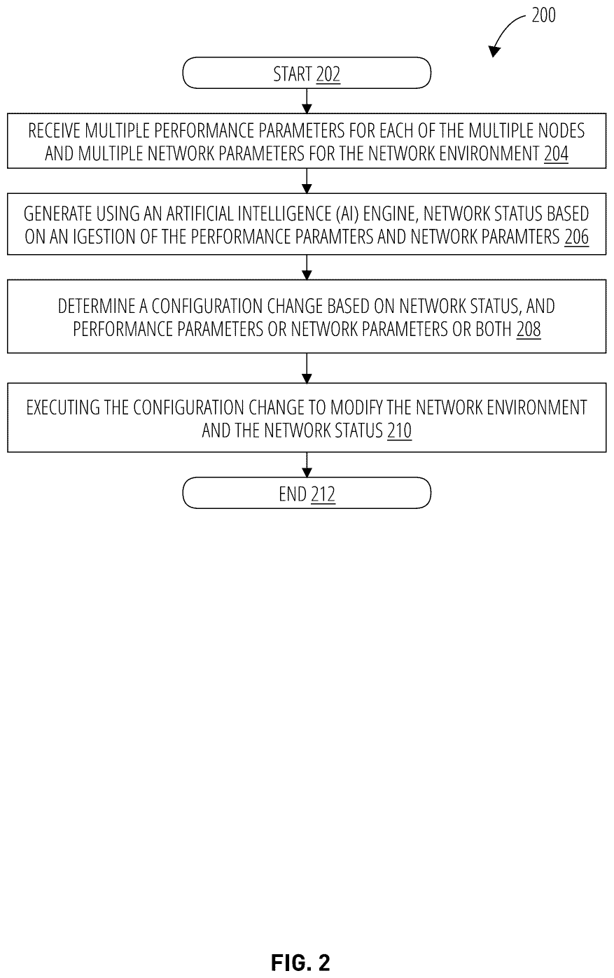

The aforementioned FSM-based approach may be implemented in conjunction with the methods described in FIGS. 2-4, wherein the network status, configuration changes, and execution steps are governed by the FSM's state logic.

The AI engine 122 includes one or more AI models, such as an identifier AI model and a prediction AI model, each of which may further include an ensemble of AI models.

In some embodiments, the identifier AI model is trained using training data having inputs including performance parameters and the network parameters, and labels including the node identifier, performance state, performance parameter causing the performance state, the network state, and the network parameter causing the network state. Such training data is validated, for example, by humans, rule-based algorithms, or other known techniques. In some embodiments, the identifier AI model is trained using supervised learning, unsupervised learning, reinforcement learning, and other training techniques as known in the art. In some embodiments, the identifier AI model is trained to identify the status of a node (110) based on the performance parameters for all nodes 110, all available nodes (in case some nodes are unavailable), or multiple nodes (less than all available nodes) of the customer environment 102. The trained identifier AI model of the AI engine 122 generates the status of the node 110 from the performance parameters, as discussed above.

In some embodiments, the prediction AI model is trained using training data including the probability score for a node from probability module 124, optionally the network status from the nodes 110, and labels including network status at the time at which the performance state and/or the network state occurred. Such training data is validated, for example, by humans, rule-based algorithms, or other known techniques. In some embodiments, the prediction AI model is trained using supervised learning, unsupervised learning, reinforcement learning and other training techniques as known in the art. In some embodiments, the prediction AI model is trained based on the performance parameters associated with a single node, or all available nodes (in case some nodes are unavailable), or multiple nodes (less than all available nodes), and the network parameters of the network environment 102. The trained prediction AI model of the AI engine 122 generates the time interval for a performance event for a node, as discussed above. Various thresholds discussed herein can be predefined, for example, by a user, determined by the AI engine 122, or be redefined by the AI engine 122. The AI engine 122 is configured to learn over time as the AI engine 122 receives more data on the nodes 110 of the network environment 102, and all performance events or issues, failures of the nodes. Over time, with this enhanced learning, the AI engine 122 becomes more accurate and faster in predicting when a node (110) or an associated entity or resource will degrade and/or fail.

The probability module 124 is configured to compute a probability of occurrence of a performance event for the node 110 for one or more future time intervals, based on the status of the node 110. In some embodiments, the probability module 124 computes the probability based further on one or more of, all historical network status data for the node 110, only the historical status data for the node 110 having the same performance parameter at cause as that identified by the identifier AI model, or all or some historical data of the performance parameters and the network parameters as cause identified by the identifier AI model. The probability module 124 utilizes any known probability function or functions to compute the probability of occurrence of the performance event for the node 110, including but not limited to, normal distribution, Bernoulli distribution, uniform distribution, binomial distribution, Poisson distribution, exponential distribution, among others known in the art. In other embodiments, the probability module 124 may use any machine learning model that receives time series of the network status as input and generates a probability score as an output. The machine learning model may use any one or combination of including, but not limited to, linear regression, logistic regression, decision trees, random forest trees, support vector machines, multi-level perceptrons, ensemble models, neural networks, recurrent neural networks, and the like.

The user device 106 is a computing device as known in the art accessible to a user 128, such as an administrator of the network environment 102. The user device 106 includes the GUI 126 configured to display information and receive instructions from the user 128. In some embodiments, the user device 106 is a node 110 of the network environment 102. In some embodiments, the user device 106 is a device outside of the network environment 102, as shown in FIG. 1, and is configured to send and receive information over the network 108.

The network 108 is a communication network, such as any of the several communication networks known in the art, and for example a packet data switching network such as the Internet, a proprietary network, a wireless Global System for Mobile (GSM) network, among others. The network 108 is capable of communicating data to and from the customer environment 102, the nodes 110 therein, the PAS 104 and the user device 106.

An optimizer module 130 is implemented in the memory 118. The optimizer module 130 is configured to determine a configuration change based on at least one of, the at least one performance parameter or the at least one network parameter, as generated in the network status. In some embodiments, the configuration change may be indicative of changes to the configuration, specification, or manner of operations of the nodes 110 that optimize its performance. In some examples, the configuration change may correspond to at least one of, dynamic resource allocation, activation of firewalls, traffic flow optimization, traffic distribution, Quality of Service (QoS) optimization, anomaly detection and troubleshooting, predictive analysis, dynamic load balancing, Software-Defined Wide Area Network (SD-WAN) optimization, packet level optimization, network slicing, auto-configuration and provisioning of network, or energy optimization, but not limited thereto. The configuration change is determined either based on the network status generated by the AI engine 122, or the forecasted network status determined by the probability module 124.

The optimizer module 130, to determine the configuration change, may be configured to identify a subset of nodes from the nodes 110 that are associated with the at least one performance parameter, or the at least one network parameter causing the performance state of the each of the plurality of nodes, and/or at least a portion of the network environment 102 causing the network state of the plurality of nodes, respectively. The subset of nodes is recognized as the group of nodes that require configuration changes to optimize their performance. To determine these configuration changes, the optimizer module 130 generates a set of potential configuration changes that could shift the network status of the subset of nodes towards a desired network status. The desired network status is configured to optimize the operation of the nodes based on the performance parameters and the network parameters of the subset of nodes. From this set, the optimizer module 130 selects the optimal configuration change. In some embodiments, the optimizer module 130 may use any one or combination of including, but not limited to, rule-based methods, expert systems, search algorithms like A*, beam search, etc., optimization algorithms like gradient descent, machine learning, and the like, to select the configuration change from the set of configuration changes.

The optimizer module 130 determines the required configuration change by comparing at least one performance or network parameter with a corresponding threshold range. Based on this comparison, the optimizer module 130 determines one or more instructions needed to modify these parameters. The one or more instructions may be executable by hardware and/or software components of the nodes 110/subset of nodes. As a result of execution of the instructions by the subset of nodes, at least one performance parameter or network parameter may be brought to a value within the corresponding threshold range, thus optimizing the operation of the subset of nodes. In some embodiments, the determination of the configuration change may be based on a comparison of at least one of the network environment configuration with a known standard network configuration, or configuration of at least one node (e.g., node 110) from the plurality of the nodes with a known standard configuration of the at least one node 110.

In some examples, the configuration change may be indicative of dynamic resource allocation. Examples of resources may include bandwidth, CPU, memory, and other parameters/specifications of the nodes. In some embodiments, if a first node has a capacity to handle 1000 requests per second, and a second node has a capacity to handle 200 requests per second, the demand/traffic to the plurality of nodes may be distributed between the first and second node in 1:5 ratio. In other embodiments, the ratio may be dynamically determined based on available resources. In some examples, when the second node is handling 1500 requests per second and is available to handle 500 additional requests, and when the first node is available to handle 1000 requests per second, the traffic to the first and second node may be distributed in 2:1 ratio. In such embodiments, the resources of the nodes 110 may be optimally utilized while minimizing overloading any single or subset of nodes, which may otherwise cause it to be more likely for failure or cause it to provide substandard performance.

In other examples, the configuration change may be indicative of the activation of firewalls. For instance, at least one performance parameter or at least one network parameter may be indicative of a security measure parameter. The security measure parameter may indicate that the network environment 102 is under a security risk such as a potential Distributed Denial of Service (DDoS) attack. In such examples, the optimizer module 130 may determine the configuration change indicating the need for activation of firewall protection. The configuration change may include the activation of firewalls on specific nodes 110, or the activation of a more comprehensive firewall system covering the entire network environment 102.

In further examples, SD-WAN optimization may include dynamic path selection, application-aware routing, and optimization of traffic over multiple network links determined by the AI engine 122 for optimized communication and load distribution in the network formed by the plurality of nodes. In some embodiments, packet level optimization comprises packet size, transmission rates, and error recovery mechanisms selected by the AI engine 122 for optimized communication. In some embodiments, the AI engine 122 may be configured to determine the changes to be made to the configuration/settings of the nodes to allow for optimized operation of the network environment 102.

In some embodiments, the PAS 104 may include an executor module 132. The executor module 132 is configured to execute the configuration changes determined by the optimizer module 130 and modify the network status based on the same. The execution of the configuration change includes transmitting a set of signals to the subset of nodes. The set of signals may include one or more instructions that are executable by the subset of nodes. Once executed, these instructions bring about the necessary configuration changes in the subset of nodes that modify the network status of the network environment 102 such that the network parameters thereof and the performance parameters of the nodes 110 move to a value within the corresponding threshold range. In some embodiments, the instructions may be configured to be transmitted through any one or more levels of the OSI model. In some examples, the set of signals may be indicative of Application Programming Interface (API) calls. In some embodiments, the executor module 132 may be indicative of an autonomous agent configured to make API calls based on natural language instructions.

In some embodiments, the executor module 132 may communicate with an operator of the network environment 102 and instruct them to manually execute the configuration change. In some embodiments, to indicate the configuration change to the operator, the set of signals may include natural language instructions that are displayed on a screen of a computing device used by the operator (such as GUI 126). In some embodiments, the AI engine 122 may indicate to the operator to vertically and/or horizontally scale/upgrade the plurality of nodes 110.

The optimizer module 130 and the executor module 132 may allow the network environment 102 to operate optimally and efficiently. By receiving the performance parameters and the network parameters related to the operation and status of each of the nodes 110, the disclosed computing apparatus 100 may identify a node that could experience performance degradation in the future using AI and machine learning techniques/models, as described above.

The PAS 104 may allow administrators to anticipate and proactively respond to potential issues that may occur in the network environment 102. Once a potential issue is identified, the optimizer module 130 determines the configuration changes needed to prevent and/or mitigate the issues, and the executor module 132 implements the configuration changes either by transmitting signals containing instructions to the nodes 110, or by communicating the suggested changes to an operator for manual implementation.

FIG. 2 depicts a flow diagram of a method 200 for determining optimized network configuration, for example, for the network environment 102 of FIG. 1, in accordance with an embodiment. In some embodiments, the PAS 104 of the apparatus 100 performs the method 200.

The method 200 starts at step 202, and at step 204, the method 200 includes receiving, at a performance analysis server (PAS), such as PAS 104 of FIG. 1 for example, from a plurality of nodes, a plurality of performance parameters for each of the plurality of nodes, and a plurality of network parameters. The network parameters include at least one of, traffic parameters, usage parameters, or bandwidth parameters, but not limited thereto. The performance parameters and the network parameters may be transmitted from the nodes (such as nodes 110) of the network environment (such as network environment 102 of FIG. 1) to the PAS 104.

At step 206, the method 200 includes generating, using an artificial intelligence and/or machine learning engine, such as the AI engine 122 of FIG. 1, for example, based on the plurality of performance parameters, a network status for the plurality of nodes. As discussed above, the network status includes at least one of, a performance state of each node in the plurality of nodes based on the performance parameters, where at least one performance parameter from the plurality of performance parameters causes the performance state (which may be identified by the AI engine 122). The network status may also include a network state of the plurality of nodes based on the plurality of network parameters, where at least one network parameter from the plurality of network parameters causes the network state (which may also be identified by the AI engine 122).

At step 208, the method 200 includes determining a configuration change based on at least one of, the at least one performance parameter or the at least one network parameter. The configuration change may be determined by an optimizer module, such as the optimizer module 130, of the PAS 104. In some embodiments, to determine the configuration change, the method 200 may include identifying a subset of nodes where the performance parameters or at least a portion of the network environment causing the performance state and the network state, respectively. The method 200 further includes generating, using the optimizer module, a set of configuration changes that shift the network status of the plurality of nodes to a desired network status based on the performance parameters and the network parameter of the network environment, where the desired network status optimizes operation of the plurality of nodes. The optimizer module may select the configuration change from the set of configuration changes.

At step 210, the method 200 includes executing the configuration change to modify the network status. An executor module, such as the executor module 132 of FIG. 1, may be used to execute the configuration change. In some examples, the executor module 132 may execute the configuration change by transmitting one or more instructions executable by the nodes 110 of the network environment. The execution of the instructions may allow the configuration/specification of the nodes to be modified such that the network status improves, and moves to a value within a corresponding threshold range. The method 200 proceeds to step 212, at which the method 200 ends.

Although the example method 200 depicts a particular sequence of operations, the sequence may be altered without departing from the scope of the present disclosure. For example, some of the operations depicted may be performed in parallel or in a different sequence that does not materially affect the function of the method 200. In other examples, different components of an example device or system that implements the method 200 may perform functions at substantially the same time or in a specific sequence.

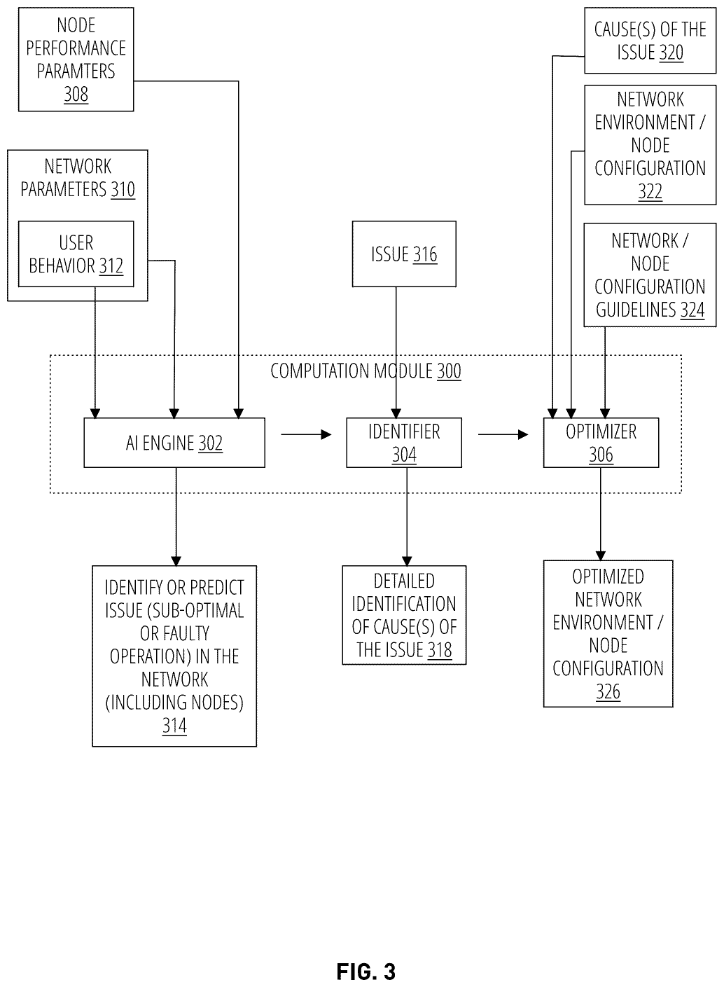

FIG. 3 depicts a functional representation of a computation module 300 for determining optimized network configuration, in accordance with an embodiment. The computation module 300 includes an AI engine 302, an identifier 304, and an optimizer 306.

The AI engine 302 is trained on various parameters of a network environment, for example, the network environment 102. Various parameters include performance parameters 308 relating to the nodes 110, for example, the hardware performance of the nodes and the software (applications 111) performance of (applications running on) the nodes; and network parameters 310 that relate to the network or the usage thereof, for example, the bandwidth of the connections (134-142) of the network (i.e., between nodes), the traffic patterns of the network, anomalies in any of the layers of the OSI model, or user behavior 312 (usage) as it relates to any aspect of the network environment 102. In some embodiments, the agents 112, which are also applications, send the parameters to the AI engine 302. The AI engine 302 is trained to associate such input parameters with failures or issues 314 in the network environment 102, such as sub-optimal performance of any portion(s) of the network environment 102, or any components thereof, including, for example, the nodes. The AI engine 302 includes one or more models arranged in different configurations, and optionally non-AI computation elements, for example, using techniques as known in the art.

The AI engine 302 identifies the issues 314, which are then input to the identifier 304. The issues 314 and the issues 316 are the same. The identifier 304 identifies cause(s) of the issue or issues 318, for example, using known techniques, such as comparing actual operation and/or behavior with operation and/or behavior according to guidelines for the nodes 110 and or the network environment 102.

The optimizer 306 uses the causes 318 (which are the same as the causes 320), and a comparison of actual network environment/node configuration 322 and network/node configuration guidelines 324 to arrive at one or more potential configuration changes 326 to address the one or more issues (314 or 316). The one or more potential configuration changes 326 may then be presented to an administrator of the network environment 102 for selection or further modification. Any further modification may be evaluated by the optimizer 306 to identify if the proposed modification achieves desired operational efficiency of the network environment. The selected configuration modification(s) are then implemented using known techniques. The configuration modifications may include, without limitation, changing one or more components, swapping one or more components, changing the usage, changing the traffic patterns, changing the bandwidth, controlling data transfer for one or more OSI model layers, among other known modifications.

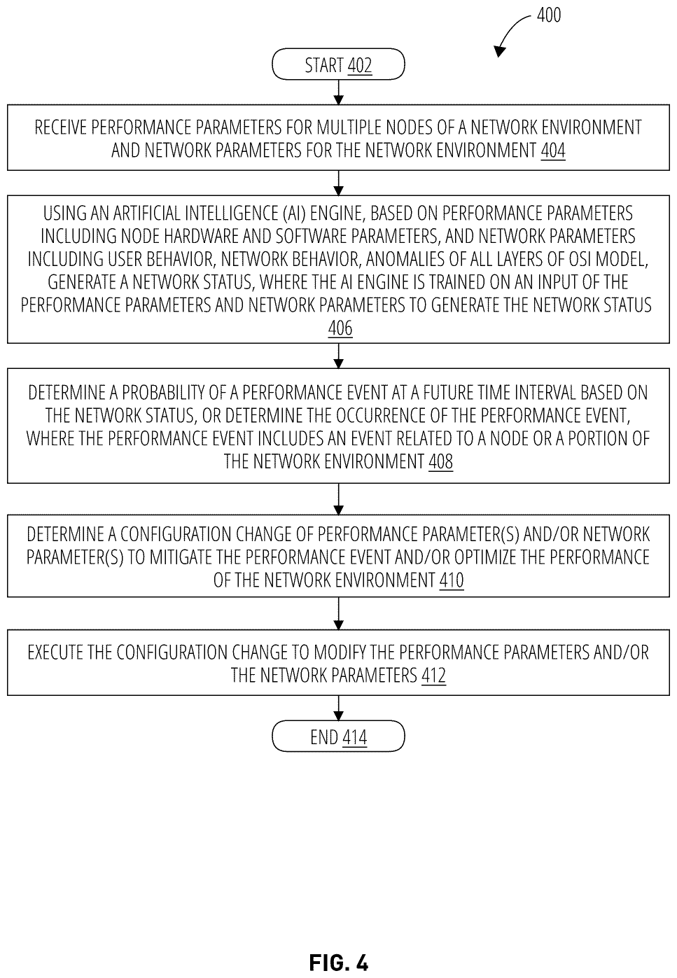

FIG. 4 depicts a flow diagram of a method 400 for determining optimized network configuration, in accordance with an embodiment. In some embodiments, the method 400 utilizes the computation module 300 of FIG. 3.

According to some examples, the method 400 includes starting at step 402.

According to some examples, the method 400 includes receiving performance parameters for multiple nodes of a network environment and network parameters for the network environment at step 404. The performance parameters and/or the network parameters may be obtained from log files or log data maintained by nodes in the network environment (such as nodes 110 of the network environment 102 of FIG. 1). The log files/data may include logs recorded for communication and/or processing in at least one layer of the OSI model. The performance parameters and/or the network parameters may be received and/or derived from the log data. In some embodiments, different processing modules (which may use any one or a combination of, AI/machine learning models, expert systems, statistical functions, data analytics modules, and the like, but not limited thereto) may be used to process and derive the performance and/or network parameters.

According to some examples, the method 400 includes using an AI engine (such as AI engine 302 or 122), based on performance parameters including node hardware and software parameters, and network parameters including user behavior, network behavior, anomalies of all layers of OSI model, generate a network status. The network status may include a performance status of each of the nodes of the network environment, and a network status of the network environment. The network status may also include at least one performance parameter that causes the performance state of the node (such as high temperature of the node causing sub-optimal performance of the node), and at least one network parameter causing the network state of the network environment (such as high bandwidth requirements of one node causing network congestions at a portion of the network environment). The AI engine is trained on an input of the performance parameters and network parameters to generate the network status, at step 406.

According to some examples, the method 400 includes determining a probability of a performance event at a future time interval based on the network status, or determine the occurrence of the performance event, where the performance event includes an event related to a node or a portion of the network environment at step 408. The probability may be determined using a probability module, such as probability module 124 of FIG. 1. Determining the probability may allow the network status to be forecasted/predicted, such as for predictive maintenance, for example.

According to some examples, the method 400 includes determining a configuration change of performance parameter(s) and/or network parameter(s) to mitigate the performance event and/or optimize the performance of the network environment at step 410. The method 400 not only allows the network status to be determined (at step 406) and/or forecasted (at step 408), but also recommend (configuration) changes to be made to maintain/continue to operate the network environment efficiently or at desired/optimal levels. In some embodiments, the configuration change may be determined by selecting those configuration changes from a list, that are appropriate to prevent or mitigate the network status (or bring or maintain the network status at a desired state). To determine the configuration change, the method 400 may include comparing at least one of, the at least one performance parameter, or the at least one network parameter with a corresponding threshold range; and determining, using an optimizer module, one or more (processor-executable) instructions to modify at least one of, the at least one performance parameter or the at least one network parameter. The instructions, when executed by the plurality of nodes, cause at least one of: the at least one performance parameter, or the at least one network parameter to be within the corresponding threshold range. Alternatively, or additionally, the method 400 may include determining the configuration change based on a comparison of at least one of, a network environment configuration with a known standard network configuration, or configuration of at least one node from the plurality of the nodes with a known standard configuration of the at least one node.

According to some examples, the method 400 includes executing the configuration change to modify the performance parameters and/or the network parameters at step 412. The configuration change may be implemented by executing the instructions corresponding to the configuration change at the nodes of the network environment. The configuration change may also be implemented manually by an operator, where the configuration change may be intimated to the operator as a signal or a message.

According to some examples, the method 400 includes ending at step 414.

Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

The methods described herein may be implemented in software, hardware, or a combination thereof, in different embodiments. In addition, the order of steps in methods can be changed, and various elements may be added, reordered, combined, omitted, or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of embodiments that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” and the like, indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to effect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing platform or a “virtual machine” running on one or more computing platforms). For example, a machine-readable medium can include any suitable form of volatile or non-volatile memory.

In addition, the various operations, processes, and methods disclosed herein can be embodied in a machine-readable medium and/or a machine accessible medium/storage device compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium/storage device.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected. Other technical features may be readily apparent to one skilled in the art from the following figures, descriptions, and claims.

What is claimed is:

1. A computer implemented method for determining optimized network configuration, the method comprising:
receiving, at a performance analysis server (PAS), from a plurality of nodes of a network environment, a plurality of performance parameters for each of the plurality of nodes and a plurality of network parameters for the network environment; and
generating, using an artificial intelligence and/or machine learning (AI) engine, based on at least one of: the plurality of performance parameters, or the plurality of network parameters, a network status for the network environment, the network status comprising at least one of:
a performance state of a node from the plurality of nodes, wherein at least one performance parameter from the plurality of performance parameters causes the performance state, or
a network state of at least a portion of the network environment, wherein at least one network parameter from the plurality of network parameters causes the network state;
determining a configuration change based on at least one of: the performance parameter, or the network parameter.

2. The computer implemented method of claim 1, wherein the determining the configuration change is further based on a comparison of at least one of: a network environment configuration with a known standard network configuration, or configuration of at least one node from the plurality of the nodes with a known standard configuration of the at least one node.

3. The computer implemented method of claim 1, wherein the at least one performance parameter of the node comprises at least one of: a status of hardware or a software of the node, and wherein the at least one network parameter comprises at least one of: a bandwidth, traffic, or anomalies in at least one layer of the open systems interconnection (OSI) model, or usage of the node or the network environment.

4. The computer implemented method of claim 1, wherein the determining the configuration change comprises:
identifying, a subset of nodes from the plurality of nodes associated with at least one of: the at least one performance parameter causing the performance state of each of the subset of nodes, or at least a portion of the network environment causing and the network state of the plurality of nodes respectively;
generating, using an optimizer module, a set of configuration changes that shift the network status of the plurality of nodes to a desired network status based on at least one of: the at least one performance parameter of the subset of nodes, or the at least one network parameter of the network, wherein the desired status is configured to optimize operation of the plurality of nodes; and
selecting the configuration change from the set of configuration changes.

5. The computer implemented method of claim 1, wherein the determining comprises:
comparing at least one of: the at least one performance parameter, or the at least one network parameter with a corresponding threshold range; and
determining, using an optimizer module, one or more instructions to modify at least one of: the at least one performance parameter or the at least one network parameter, wherein the one or more instructions, when executed by the plurality of nodes, cause at least one of: the at least one performance parameter, or the at least one network parameter to be within the corresponding threshold range.

6. The computer implemented method of claim 1, further comprising:
forecasting, using the AI engine, the network status of the plurality of nodes for a first time interval in the future; and
determining the configuration change based on the forecasted network status.

7. The computer implemented method of claim 1, wherein the configuration change comprises at least one of: dynamic resource allocation, activation of firewalls, traffic flow optimization, traffic distribution, Quality of Service (QoS) optimization, anomaly detection and troubleshooting, predictive analysis, dynamic load balancing, Software-Defined Wide Area Network (SD-WAN) optimization, packet level optimization, network slicing, auto-configuration and provisioning of network, or energy optimization.

8. The computer implemented method of claim 1, comprising executing the configuration change to modify the network status.

9. The computer implemented method of claim 8, wherein the executing comprises transmitting a set of signals to the plurality of nodes to execute the configuration change determined by the AI engine, wherein the set of signals comprises one or more instructions executable by the plurality of nodes.

10. The computer implemented method of claim 9, wherein the set of signals to indicate to an operator to manually execute the configuration change.

11. The computer implemented method of claim 9, wherein the set of signals are transmitted through signals transmitted through at least one level of open system interconnection (OSI) model.

12. The computer implemented method of claim 1, wherein the plurality of performance parameters comprises at least one of: device performances, errors, usage timing, utilization of the network bandwidth, network key performance indicators (KPI), current network configuration, topology, segmentation, software versions of the plurality of nodes, traffic patterns, check protocol performances, security measures, Internet Protocol (IP) provisioning, network diameter, jitter, power consumption, or Voice-over IP (VOIP) quality.

13. A computing apparatus, comprising:
a processor; and
a memory storing instructions that, when executed by the processor, configure the apparatus to:
receive, at a performance analysis server (PAS), from a plurality of nodes of a network environment, a plurality of performance parameters for each of the plurality of nodes and a plurality of network parameters for the network environment; and
generate, using an artificial intelligence and/or machine learning (AI) engine, based on at least one of: the plurality of performance parameters, or the plurality of network parameters, a network status for the network environment, the network status comprising at least one of:
a performance state of a node from the plurality of nodes, wherein at least one performance parameter from the plurality of performance parameters causes the performance state, or
a network state of at least a portion of the network environment, wherein at least one network parameter from the plurality of network parameters causes the network state;
determine a configuration change based on at least one of: the performance parameter or the network parameter.

14. The computing apparatus of claim 13, wherein the determination of the configuration change is further based on a comparison of at least one of: a network environment configuration with a known standard network configuration, or configuration of at least one node from the plurality of the nodes with a known standard configuration of the at least one node.

15. The computing apparatus of claim 13, wherein the at least one performance parameter of the node comprises at least one of: a status of hardware or a software of the node, and wherein the at least one network parameter comprises at least one of: a bandwidth, traffic, or anomalies in at least one layer of the open systems interconnection (OSI) model, or usage of the node or the network environment.

16. The computing apparatus of claim 13, wherein to determine the configuration change comprises, the instructions further cause the computing apparatus to:
identify, a subset of nodes from the plurality of nodes associated with the at least one performance parameter causing the performance state of each of the subset of nodes, or at least a portion of the network environment causing and the network state of the plurality of nodes respectively;
generate, using an optimizer module, a set of configuration changes that shift the network status of the plurality of nodes to a desired network status based on at least one of: the at least one performance parameters of the subset of nodes, or the at least one network parameter of the network, wherein the desired status is configured to optimize operation of the plurality of nodes; and
select the configuration change from the set of configuration changes.

17. The computing apparatus of claim 13, wherein to determine the configuration change, the instructions configure the computing apparatus to:
compare at least one of: the at least one performance parameter, or the at least one network parameter with a corresponding threshold range; and
determine, using an optimizer module, one or more instructions to modify at least one of: the at least one performance parameter, or the at least one network parameter, wherein the one or more instructions, when executed by the plurality of nodes, cause at least one of: the at least one performance parameter, or the at least one network parameter to be within the corresponding threshold range.

18. The computing apparatus of claim 13, wherein the instructions further configure apparatus to:
forecast, using the AI engine, the network status of the plurality of nodes for a first time interval in the future; and
determine the configuration change based on the forecasted network status.

19. The computing apparatus of claim 13, wherein to execute the configuration change, the instructions configure the computing apparatus to transmit a set of signals to the plurality of nodes to execute the configuration change determined by the AI engine, wherein the set of signals comprises one or more instructions executable by the plurality of nodes.

20. The computing apparatus of claim 19, wherein the set of signals are transmitted through signals transmitted at any one level of open system interconnection (OSI) model.
